(19) United States
(12) Patent Application Publication
(10) Pub. No.: US 2014/0235334 A1
(43) Pub. Date: Aug. 21, 2014

(54) VIRTUAL SPACE MOVEMENT GAME MACHINE AND GAME PROGRAM

(71) Applicant: SQUARE ENIX CO., LTD., Tokyo (JP)

(72) Inventor: Toshiaki Tarumi, Tokyo (JP)

(21) Appl. No.: 13/900,944

(22) Filed: May 23, 2013

Related U.S. Application Data
(60) Provisional application No. 61/766,963, filed on Feb. 20, 2013.

(51) Int. Cl. A63F 13/00

(52) U.S. Cl. CPC A63F 13/00
USPC 463/31

(57) ABSTRACT

A virtual space movement game machine 1 wherein an operation character PC is located on a stage formed in a three dimensional virtual space and a two dimensional game image PT is formed so as to display on a display 11 by rendering with a virtual camera, has a judger 5 that judges whether the display 11 is displaying the stage by rendering, a detector 10 that detects a change of the operation character parameter of the operation character if the judgment was that the display is displaying by rendering, and means 7 that displays corresponding indicators 16, 17, 19 on the display 11 for a predetermined time regarding only the operation character parameters on which change was detected, so that no indicator is displayed as long as the change in the operation character parameter does not occur.

### TECHNICAL FIELD

The invention relates to a virtual space movement game machine and game program in which operation character parameters pertinent to an operation character, such as HP, MP, an experience point and number of remaining bullets, are not displayed on a two dimensional game image obtained by rendering a three dimensional virtual space where the operation character moves.

### BACKGROUND ART

A conventional RPG or a shooting game uses such a scenario that a player moves the operation character in a three dimensional virtual space so as to get the operation character to do predetermined actions, such as battles, between the operation character and a non-operation character, such as an enemy character.

In such a case, the operation character parameters, such as HP, MP, an experience point and number of remaining bullets, are indicated on a peripheral portion of a screen at any time, and it is possible for the player to confirm such operation character parameters at any time (for example, patent related document 1).

### PRIOR ART

### Patent Related Document

Patent related document 1: Patent application publication No. 2007-29222

### DISCLOSURE OF INVENTION

### Problems to be Solved by Invention

But, in such a structure, the operation character parameters indicated on the peripheral portion of the screen damage a reality since the operation character parameters are indicated on the screen at any time even if an object in a virtual space is precisely composed so as to resemble an actual subject and is rendered. For this reason, funs of the game may be damaged.

If the operation character parameters are not indicated on the scenario game screen at all and are indicated only upon request from the player through an operation of an input portion, it is necessary to input a command that requests to indicate the operation character parameters in a battle scene where such parameters may change as well as command input for normal battle actions. Then, the game may have extremely bad operability.

Then, an object of the invention is to provide the virtual space movement game machine and game program wherein it is possible to get rid of the indication of the operation character parameters pertinent to the operation character, such as HP, MP, an experience point and number of remaining bullets as much as possible on the two dimensional game image obtained by rendering the three dimensional virtual space, and if there is a change in the operation character parameters, it is possible to properly indicate such an operation character parameter on the two dimensional game image.

### Means for Solving Problems

A first aspect of the invention is a virtual space movement game machine (1) wherein an operation character (PC) to be operated by a player on which two or more kinds of operation character parameters (such as HP, MP, remaining number of bullets, damage and experience point) are set is located on a stage formed in a three dimensional virtual space, and a two dimensional game image (PT) is produced by rendering the stage with a virtual camera and is displayed on a display (11), comprising:

a rendering judger (5) that judges whether the display (11) is displaying the two dimensional game image (PT) by rendering the stage with the virtual camera;

a parameter change detector (10) that detects a change of the operation character parameter of the operation character if the judgment was that the display (11) is displaying by rendering; and

an indicator display (7) that displays an indicator (16, 17, 19) corresponding to the operation character parameter on the two dimensional game image (PT) for a predetermined time for only the operation character parameter on which change was detected;

whereby the indicator corresponding to the operation character parameter is not indicated on the two dimensional game image (PT) as long as a change does not occur in the operation character parameter.

A second aspect of the invention is the virtual space movement game machine, further comprising a battle condition judger (13) that judges whether the operation character (PC) is in the middle of battle on the stage if the judgment was that the rendering is doing, wherein the parameter change detector (10) detects a change of the operation character parameter if the battle condition judger (13) judged that the operation character (PC) is in the middle of battle on the stage.

A third aspect of the invention is the virtual space movement game machine 1, further comprising a target locator (5) that locates an enemy target on the stage, an arms equipper (5) that can equip the operation character with the shooting arms (GN) according to a command input from the input portion (12), and a battle processor (5) that does a battle process by the shooting arms (GN) between the operation character (PC) and the enemy target on the stage.

A fourth aspect of the invention is the virtual space movement game machine 1, wherein the indicator display (7) displays the indicator on the two dimensional game image (PT) for several seconds.

A fifth aspect of the invention is program in a computer (1) wherein an operation character (PC) to be operated by a player on which two or more kinds of operation character parameters (such as HP, MP, remaining number of bullets, damage and experience point) are set is located on a stage formed in a three dimensional virtual space, and a two dimensional game image (PT) is produced by rendering the stage with a virtual camera and is displayed on a display (11):
the program for getting the computer (1) to function as following means:

a rendering judger (5) that judges whether the display is displaying the two dimensional game image (PT) by rendering the stage with the virtual camera;

a parameter change detector (10) that detects a change of the operation character parameter of the operation character if the judgment was that the display (11) is displaying by rendering; and

an indicator display (7) that displays an indicator (16, 17, 19) corresponding to the operation character parameter on the two dimensional game image (PT) for a predetermined time for only the operation character parameter on which change was detected;

whereby the program controls the computer not to indicate the indicator corresponding to the operation character parameter on the two dimensional game image (PT) as long as a change does not occur in the operation character parameter.

### Effects of Invention

According to the first to fifth aspects of the invention, the operation character parameter of the operation character (PC) is not displayed on the two dimensional game image (PT) during rendering the stage as long as the change in the value does not occur. Then, it is possible to constitute the two dimensional game image from only image obtained by purely rendering the stage, and to improve the reality of the two dimensional game image (PT) thereby. If the change in the operation character parameter occurs, the corresponding indicator is displayed for a predetermined time. So, the progress of the game with no stress is possible without inputting a command of requesting the indication of the operation character parameter through the player.

According to the second aspect of the invention, in many cases, the change of the operation character parameter occurs during the battle between the operation character (PC) and the enemy target, and it is possible to save vain operation processing in the middle of non-battle.

According to the third aspect of the invention, it is possible to provide the shooting game with the shooting arms (GN).

According to the fourth aspect of the invention, it is possible to reduce the inhibition of the reality of the two dimensional game image (PT) since the indicator is displayed for only predetermined number of seconds.

The number in parentheses shows the corresponding element in the drawings for the sake of convenience, accordingly, the descriptions are not restricted and bound by the descriptions on the drawings.

### BRIEF DESCRIPTION OF DRAWINGS

FIG. 1 is a view that shows an example of a two dimensional game image in a third person shooting game.

FIG. 2 is a view that shows an example of the image of FIG. 1 on which a reload indicator is indicated.

FIG. 3 is a view that shows an example of the image of FIG. 1 on which an aim is indicated.

FIG. 4 is a view that shows an example of the image of FIG. 1 on which an experience point indicator is indicated.

FIG. 5 is a view that shows an example of the image of FIG. 1 on which a damage indicator is indicated.

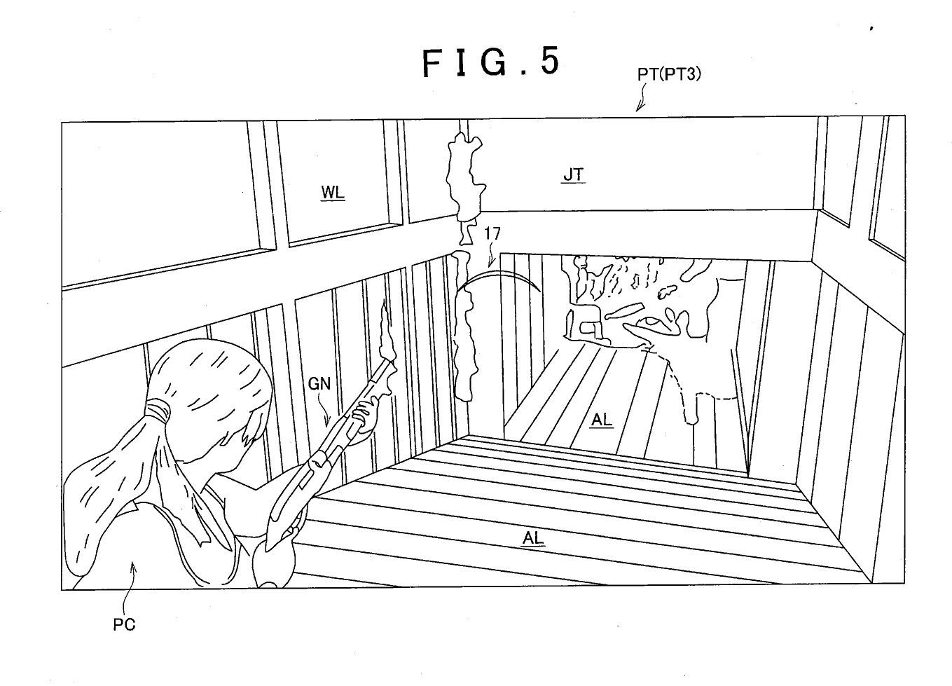

FIG. 6 is a view that shows an example of the image of FIG. 1 on which a remaining bullet number indicator is indicated.

FIG. 7 is a control block diagram that shows an example of a virtual space movement game machine.

FIG. 8 is a flowchart that shows an example of a character action analysis program.

### EMBODIMENTS FOR CARRYING OUT THE INVENTION

An embodiment of the invention is now explained, referring to appended drawings.

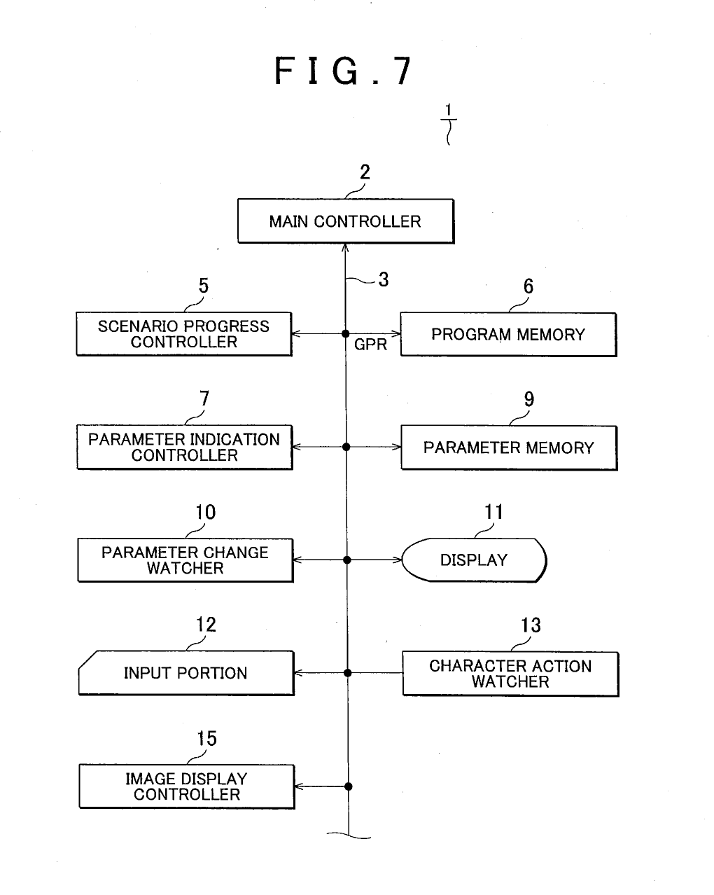

As shown in FIG. 7, a virtual space movement game machine comprising a computer 1 has a main controller 2, and a scenario progress controller 5, a program memory 6, a parameter indication controller 7, a parameter memory 9, a parameter change watcher 10, a display 11, an input portion 12, such as a controller and a keyboard, a character action watcher 13 and an image display controller 15 are connected with the main controller 2 via a bus line 3.

The virtual space movement game machine 1 as shown in FIG. 7 executes functions shown in respective blocks as shown in FIG. 7 in such a manner that a computer reads and executes game program GPR stored in the program memory 6, such as a shooting game, so that a CPU or a memory (not shown) time-dividedly operates by multitask. But, it is also possible to structure the virtual space movement game machine 1 by hardware corresponding to the respective blocks Otherwise, it is also possible to control each block by a CPU or a MPU dispersedly provided in each block.

The virtual space game machine 1 has the above-mentioned structure, and in order to execute a shooting game, for example, with the virtual space movement game machine 1, the main controller 2 reads the game program GPR out of the program memory 6 based upon a play start command from the player, and the main controller 2 controls to advance the game through the scenario progress controller 5 according to the read game program GPR. The game program GPR stored in the program memory 6 is stored in the program memory 6 of the virtual space movement game machine 1 through downloading via a communication line, such as the Internet or reading from various kinds of memory mediums that store the game program GPR.

The scenario progress controller 5 forms two or more stages in the three dimensional virtual space in a memory (not shown) according to the game program GPR, and locates an operation character PC that can be operated by the player through the input portion 10 and a necessary number of AI operation characters (such as enemy characters) to be controlled by a predetermined action algorithm through the main controller 2 according to the game program GPR on the stage. In the embodiment, the operation character PC can freely move within bounds determined by the game program GPR on the stage by the operation of the player.

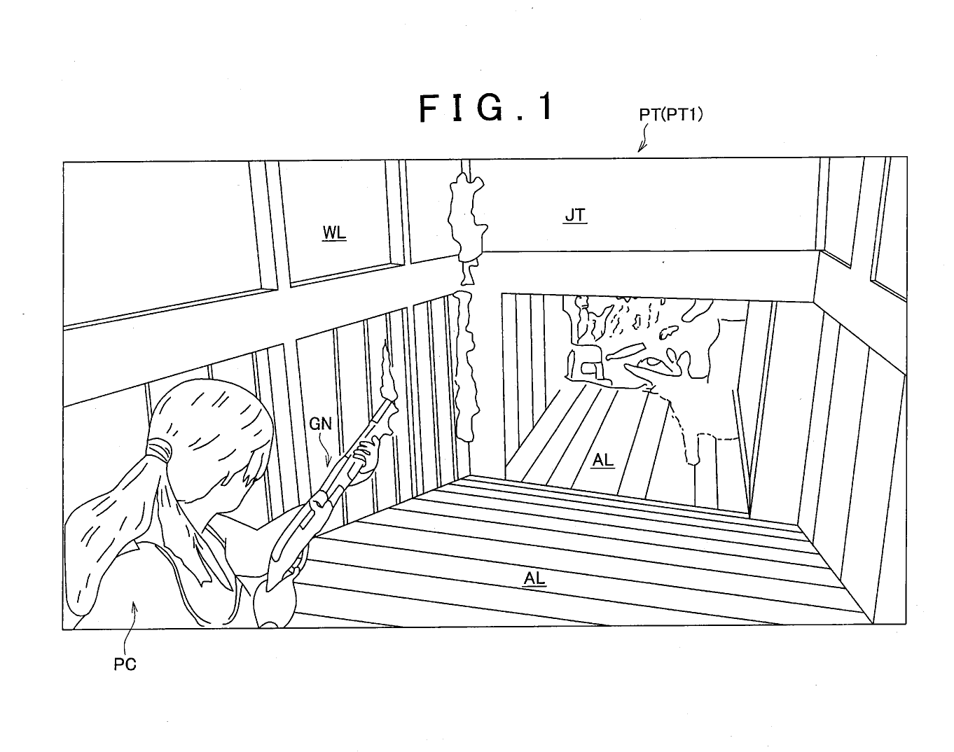

When finishing the stages in the three dimensional virtual space, the image display controller 15 renders the stage with a virtual camera (not shown) that is located in the neighbor of the operation character PC on the stage in real time according to the game program GPR so as to produce a two dimensional game image PT and display on the display 11 as shown in FIG. 1. On the two dimensional game image PT1 of FIG. 1 (if the respective game images are respectively differentiated from each other, the game image PTn: n=1, 2 . . . n is indicated, and if differentiation is not necessary, only the game image PT is indicated), a rendering image of the operation character PC to be operated by the player and a rendering image of a background object JT formed on the stage where the operation character PC is moved, such as a building, are displayed. In a case of FIG. 1, a passage AL on which the operation character PC can move, and its peripheral wall WL are displayed as the background objects JT. The operation character PC owns shooting arms GN, such as guns and archeries, so as to freely equip through a command input operation of the player via the input portion 10 by the scenario progress controller 5 according to the game program GPR. The player is possible to aim for and shoot for the proper object on the stage by operating the shooting arms GN through the input portion 10. At the result, a damage determined by the game program GPR can be given to the enemy character as the AI operation character. The scenario progress controller 5 computes concrete quantity of damage and a timing of damage outbreak with a well-known method according to the game program GPR.

If the operation character PC overthrows an enemy target that is the AI operation character, such as the enemy character, with the shooting arms GN, it is possible to obtain a predetermined experience point determined by the game program GPR. The obtained experience points are added to data of accumulated experience points that is stored in the parameter memory 9 through the scenario progress controller 5 so as to be updated. Whenever the value of the accumulated point reaches a predetermined value, a level of the operation character PC rises, and the operation character PC is controlled so as to have a higher power through the main controller 2 according to the game program GPR.

As mentioned before, the AI operation characters as the enemy targets (not shown) are located on the stage through the scenario progress controller 5 according to the game program GPR, and these AI operation characters are able to freely move on a place that is set as a place where the character can move by the game program GPR, such as the passage AL, according to algorithm of the game program GPR that is set on the AI characters. Furthermore, it is possible to give the damage according to the game program GPR to the operation character PC through an attack against the operation character PC with the shooting arms, if necessary. In such a case, HP that is set on the operation character PC is subtracted by a quantity corresponding to the damage. The scenario progress controller 5 computes the concrete quantity of the damage and the timing of the damage outbreak with a well-known method according to the game program GPR. That is, the game is a so-called shooting game wherein the scenario progress controller 5 executes a battle procedure with the shooting arms GN between the operation character PC and the enemy target according to the game program GPR.

Furthermore, the number of the shootable bullets at a time is set on the shooting arms GN with which the operation character PC can be equipped according to the game program GPR, and whenever the player shoots the bullet or a bow with the shooting arms GN through the operation of the operation character PC, the number of the shootable bullets (the remaining number of bullets) reduces. The scenario progress controller controls the number of shootable bullets with the shooting arms GN of the operation character PC at some point of time according to the game program GPR as the remaining number of bullets in the parameter memory 9 in real time. If the remaining number of bullets becomes zero, or a predetermined number or lower, the player executes a predetermined reloading operation according to the game program GPR through the input portion 10, so that it is possible to reset the number of shootable bullets into the reloaded number of bullets determined by the game program GPR.

The player clears the two or more stages in order while moving on the stage in the three dimensional virtual space through the operation of the operation character PC and overthrowing the enemy character as the AI operation character appearing on the stage with the shooting arms GN. Such a game is well known as a third person shooting game. When the player moves on the stage through the operation of the operation character PC, the camera for rendering is moved, synchronizing with the movement of the operation character PC on the stage. At the result, a background image corresponding to the present position of the operation character PC on the stage is rendered and the wall WL and the passage AL, for example, are displayed on the display 11.

As shown in FIG. 1, only the two dimensional game image PT that was obtained by rendering the stage that is set in the three dimensional virtual space with the virtual camera is displayed as the game image PT displayed at the time when the operation character PC moves on the stage, and two or more kinds of operation character parameters, such as HP (hit point : quantity of damage that the character PC can endure: It is impossible to battle if HP becomes “0”), MP (magic point: a value that represents quantity of “magical power (spiritual strength)” that the character consumes for using a special power: If MP becomes “0”, “magical power (spiritual strength)” can not be used), the experience point, the remaining number of bullets, and various kinds of indicators, such as an icon and a map, are not displayed excluding the two dimensional game image PT. Therefore, the game image PT displayed on the display 11 is only a scene at the periphery of the operation character PC, as shown in FIG. 1, and the player can feel a big sense of reality.

But, in such a condition, it is not possible for the player to know the operation character parameters of the operation character PC from the two dimensional game image PT displayed on the display 11. Then, the scenario progress controller 5 processes to execute character action analysis program CAP (sub-routine comprising a part of the game program GPR) during rendering in the stage of the three dimensional virtual space through the virtual camera according to the game program GPR.

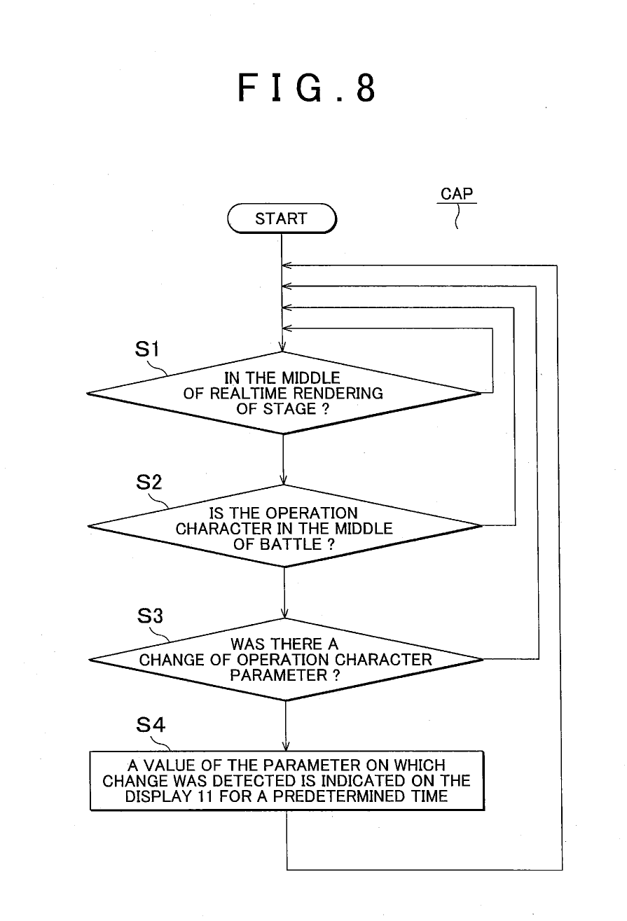

That is, the character action analysis program CAP judges whether the image display controller 15 presently performs the real-time rendering on the stage of the three dimensional virtual space through the virtual camera and the operation character PC and the background objects are displayed as the two dimensional game image PT on the display 11 as shown in FIG. 1 thereby in Step S1, as shown in FIG. 8. If not, Step S1 is repeated. If so, the program enters Step S2.

In Step S2, the character action watcher 13 judges whether the operation character PC is presently in the middle of battle on the stage where the operation character PC is located. In a case where the operation character PC is in the middle of the battle with the enemy character that is the AI character with the shooting arms GN, for example, the operation character parameters of the operation character PC, such as the HP, the MP, the remaining number of bullets and the experience points, may be changed by using the shooting arms GN at the time of the battle. At the result of the battle, a predetermined experience point may be obtained by destroying the enemy character. Various kinds of criterions can be adopted when the character action watcher 13 judges whether the operation character PC is in the middle of the battle. For example, whether the enemy character exists on the same stage of the three dimensional virtual space where the operation character PC is located is judged. If one or more enemy characters are located on the stage, “in the middle of battle” may be judged. It is possible to easily judge the presence of the enemy character since the scenario progress controller 5 locates the enemy character according to the game program GPR. If the enemy character disappears on the stage by destroying the enemy character by the operation character PC, the judgment in Step S2 is not “in the middle of battle”.

If the character action watcher 13 judges that the operation character PC is in the middle of battle in Step S2, the program enters Step S3, and the parameter change watcher 10 watches whether the operation character parameters of the operation character PC, such as the HP, the MP, the remaining number of bullets and the experience points, are changed. Such watching is carried out continuously until the judgment “in the middle of battle” disappears in Step S2, that is, the battle is finished. The operation character parameters of the operation character PC are real-timely updated and controlled through the scenario progress controller 5 in the parameter memory 9 according to the game program GPR. If there is some change in the operation character parameters, it is possible to immediately detect such a change by watching the change of the operation character parameter in the parameter memory 9.

That is, if a predetermined experience point is obtained through destruction of the enemy character, predetermined quantity of HP of the operation character PC reduces by the attack from the enemy character, the remaining number of bullets decreases through the shooting with the shooting arms GN against the enemy character, and the operation character PC takes some action of consuming the MP, the operation character parameters corresponding to these actions change. Then, the program enters Step S4, and the parameter display controller 7 displays only the operation character parameter on which the change was detected on the display 11 for a predetermined time, for several seconds, for example, according to the game program GPR.

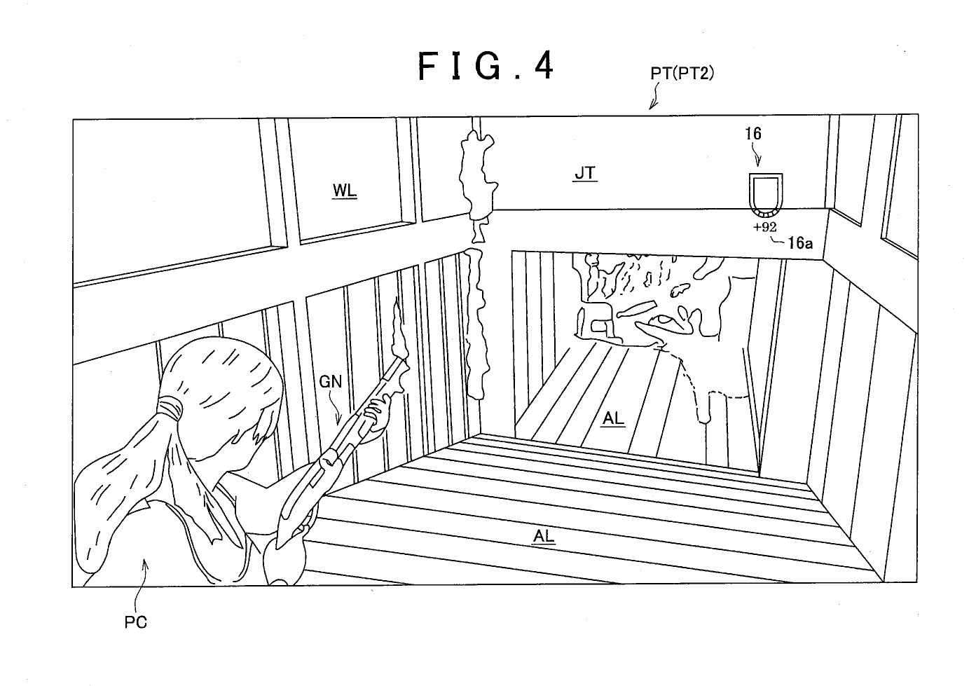

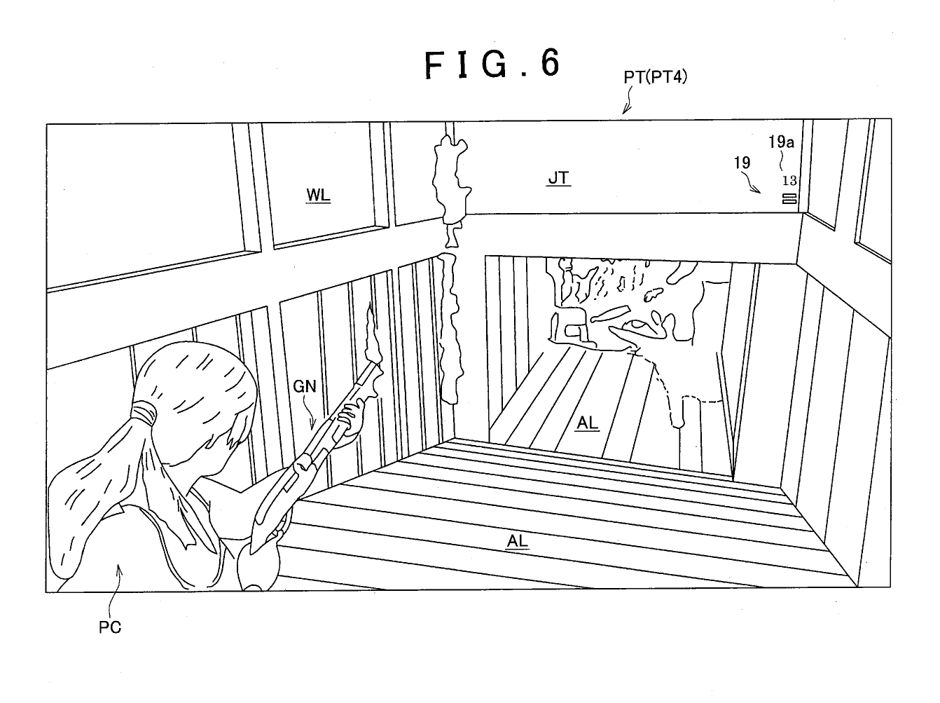

Then, on the screen of the display 11 on which only two dimensional game image PT1 obtained by rendering the stage with the virtual camera has been displayed as shown in FIG. 1, an experience point indicator 16 corresponding to the operation character parameter (experience point) on which the change was detected is displayed for several seconds and is removed thereafter, as shown in the two dimensional game image PT2 of FIG. 4, and an experience point 16a that was obtained by the player through the battle is temporarily displayed. Alternatively, a remaining bullet number indicator 19 corresponding to the operation character parameter (remaining number of bullets) on which the change was detected is displayed for several seconds as shown in the two dimensional game image PT4 of FIG. 6, and is removed thereafter, and the remaining number of bullets that the operation character PC can shoot, that is, a remaining number of bullets 19a is temporarily displayed. Anyway, it is limited to the operation character parameter that changed in the middle of battle, and the indicator corresponding to the operation character parameter on which change was detected is only displayed for a predetermined time at any time. For this reason, a sense of reality is not lost by many operation character parameters being displayed on the two dimensional game image PT for a long time. And, it is possible for the player to properly perceive such a change by watching the displayed operation character parameter. That is, as long as there is no change in the operation character parameter, no indicator corresponding thereto is displayed on the two dimensional game image PT.

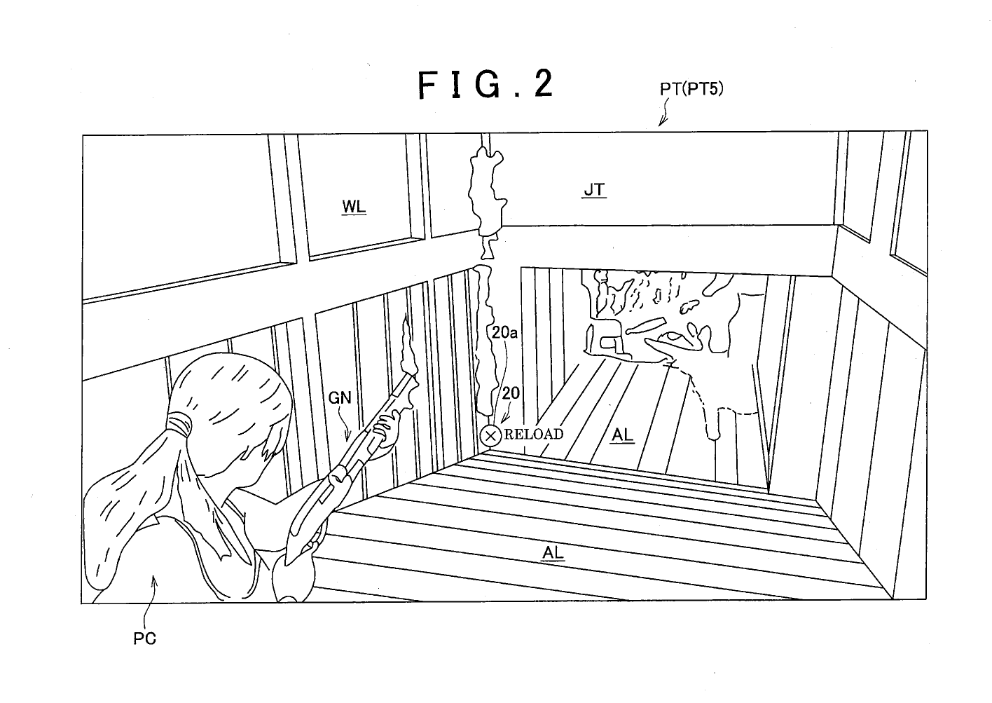

If the remaining number of bullets of the shooting arms GN of the operation character PC is zero, or a predetermined value or lower, the parameter change watcher 10 displays a reloading indicator 20 on the two dimensional game image PT through the image display controller 15 according to the game program GPR for a predetermined time as shown in the two dimensional game image PT5 of FIG. 2. The reloading indicator 20 also displays a symbol mark 20a of a button of the input portion 10 to be operated at the time when the player reloads the shooting arms GN in order to easily do the reloading operation by the player.

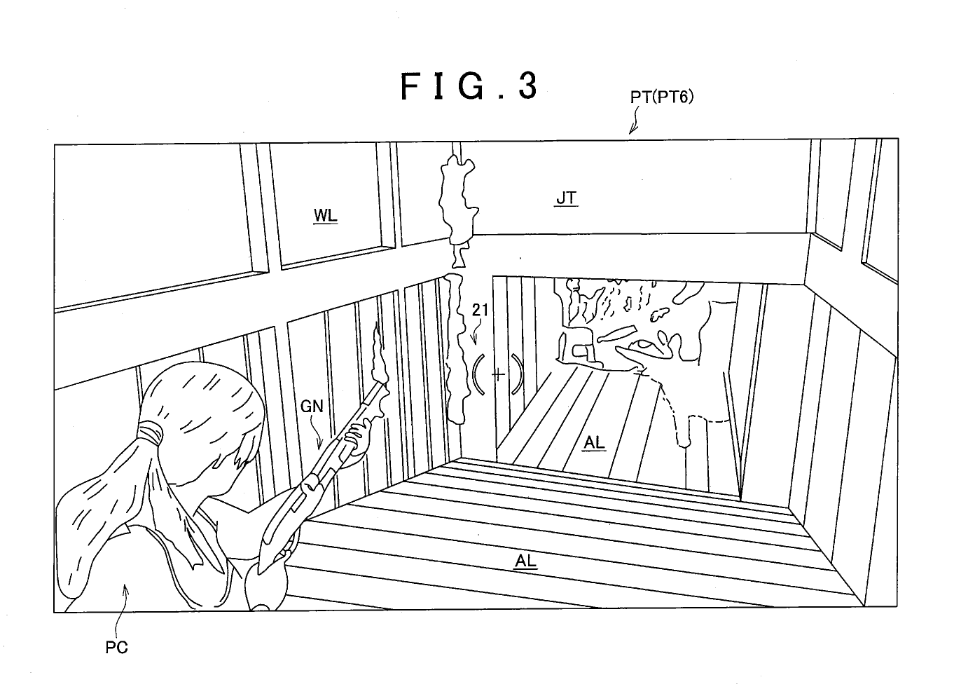

In a case where the operation character PC is equipped with the shooting arms GN, the image display controller 15 displays an aim 21 as shown with the two dimensional game image PT6 of FIG. 3 according to the game program GPR. As long as the operation character PC is equipped with the shooting arms GN, the aim 21 is displayed on the two dimensional game image PT6 at any time, but if the operation character PC takes off the equipment, the indication of the aim 21 is gone on the two dimensional game image PT6. When the player operates the shooting arms GN through the input portion 10, the aim 21 moves on the two dimensional game image PT, and if the aim 21 imposes on the enemy character on the two dimensional game image PT, the image display controller 15 controls to change an indication color from white into red, for example.

### EXPLANATION OF REFERENCE NUMBERS

1 . . . game machine
5 . . . scenario progress controller (rendering judger, arms equipper, battle processor)
7 . . . parameter indication controller (indicator display)
10 . . . parameter change watcher (parameter change detector)
12 . . . input portion
13 . . . character action watcher (battle condition judger)
16 . . . experience point indicator
17 . . . damage indicator
19 . . . remaining bullet number indicator
11 . . . display
GN . . . shooting arms
PC . . . operation character
PT . . . two dimensional game image

1. A virtual space movement game machine wherein an operation character to be operated by a player on which two or more kinds of operation character parameters are set is located on a stage formed in a three dimensional virtual space, and a two dimensional game image is produced by rendering the stage with a virtual camera and is displayed on a display, comprising:
a rendering judger that judges whether the display is displaying the two dimensional game image by rendering the stage with the virtual camera;
a parameter change detector that detects a change of the operation character parameter of the operation character if the judgment was that the display is displaying by rendering; and
an indicator display that displays an indicator corresponding to the operation character parameter on the two dimensional game image for a predetermined time for only the operation character parameter on which change was detected;
whereby the indicator corresponding to the operation character parameter is not indicated on the two dimensional game image as long as a change does not occur in the operation character parameter.

2. The virtual space movement game machine according to claim 1, further comprising a battle condition judger that judges whether the operation character is in the middle of battle on the stage if the judgment was that the rendering is doing, wherein the parameter change detector detects a change of the operation character parameter if the battle condition judger judged that the operation character is in the middle of battle on the stage.

3. The virtual space movement game machine according to claim 1, further comprising a target locator that locates an enemy target on the stage, an arms equipper that can equip the operation character with the shooting arms according to a command input from the input portion, and a battle processor that does a battle process by the shooting arms between the operation character and the enemy target on the stage.

4. The virtual space movement game machine according to claim 1, wherein the indicator display displays the indicator on the two dimensional game image for several seconds.

5. Program in a computer wherein an operation character to be operated by a player on which two or more kinds of operation character parameters are set is located on a stage formed in a three dimensional virtual space, and a two dimensional game image is produced by rendering the stage with a virtual camera and is displayed on a display:
the program for getting the computer to function as following means:
a rendering judger that judges whether the display is displaying the two dimensional game image by rendering the stage with the virtual camera;
a parameter change detector that detects a change of the operation character parameter of the operation character if the judgment was that the display is displaying by rendering; and
an indicator display that displays an indicator corresponding to the operation character parameter on the two dimensional game image for a predetermined time for only the operation character parameter on which change was detected;
whereby the program controls the computer not to indicate the indicator corresponding to the operation character parameter on the two dimensional game image as long as a change does not occur in the operation character parameter.
